(19) United States
(12) Patent Application Publication
(10) Pub. No.: US 2007/0058837 A1
(43) Pub. Date: Mar. 15, 2007

(54) Video motion detection using block processing

(75) Inventors: Lokesh R. Boregowda, Bangalore (IN); Mayur D. Jain, Akola (IN); Anupama Rajagopal, Coimbatore (IN)

Correspondence Address: SCHWEGMAN, LUNDBERG, WOESSNER & KLUTH, P.A., P.O. BOX 2938, MINNEAPOLIS, MN, 55402, US

(73) Assignee: Honeywell International Inc.

(21) Appl. No.: 11/227,588

(22) Filed: Sep. 15, 2005

(51) Int. Cl. G06K 9/00

(52) U.S. Cl. 382/103; 382/107

(57) ABSTRACT

A system detects motion in video data. In an embodiment, a difference frame is created by comparing the pixels from a first frame and a second frame. The difference frame is divided up into blocks of pixels, and the system calculates standard deviations on a block basis. A threshold value is calculated based on the standard deviation, and the presence or absence of motion is determined based on that threshold value.

### TECHNICAL FIELD

Various embodiments of the invention relate to the field of motion detection in video data, and in particular, but not by way of limitation, to motion detection in video data using block processing.

### BACKGROUND

A variety of applications for Video Motion Detection (VMD) using both simple and complex image and video analysis algorithms are known. Most of these motion detection schemes fall under one of the following categories—Temporal Frame Differencing, Optical Flow, or Background Subtraction.

Temporal differencing schemes are based on an absolute difference at each pixel between two or three consecutive frames. This difference is calculated, and a threshold is applied to extract the moving object region. One such threshold known in the art is a three-frame difference algorithm. Though this method is relatively simple to implement, it is not all that effective in extracting the whole moving region—especially the inner part of moving objects.

Optical flow based methods of motion detection use characteristics of flow vectors of moving objects over time to detect moving regions in an image sequence. In one method, a displacement vector field is computed to initialize a contour based tracking algorithm, called active rays, for the extraction of moving objects in a gait analysis. Though optical flow based methods work effectively even under camera movement, they require relatively extensive computational resources. Additionally, optical flow based methods are sensitive to noise and cannot be applied to real-time video analysis.

One of the more popular approaches to motion detection in video data is the background (BGND) and foreground (FGND) separation modeling based method. The modeling of pixels for background and foreground classification may be implemented using the Hidden Markov Model (HMM), adaptive background subtraction, and Gaussian Mixture Modeling (GMM).

The background subtraction method in particular is a popular method for motion detection, especially under static background conditions. It maintains a background reference and classifies pixels in the current frame by comparing them against the background reference. The background can be either an image or a set of statistical parameters (e.g. mean, variance, and median of pixel intensities). Most algorithms that use a background reference require a learning period to generate the background reference, and ideally, moving objects are not present during the learning period. In some cases, a simple background model can be the average image intensity over some learning period.

A background reference may be represented by the following:

$$B ( x , y , T ) = \frac{1}{T} {\sum }_{t = 1}^{T} I ( x , y , t )$$

where B indicates background pixel intensity values and I represents intensity values of images considered for building a background image. To accommodate dynamics in the scene, the background image is updated at the end of each iteration. This updated background image can then be represented by:

$$B ( x , y , T ) = \frac{( T - 1 )}{T} B ( x , y , T - 1 ) + \frac{1}{T} I ( x , y , T )$$

After the learning period, the foreground-background segmentation can be accomplished through simple distancing measures like the Mahalanobis distance.

A potential problem with this background approach is that lighting changes over time, and this change can adversely affect the algorithm. This change in lighting can be addressed by a window—based approach or by using exponential forgetting. Since a window based approach requires a good deal of storage, an exponential forgetting scheme is often followed. Such a scheme may be represented by the following:
B(x,y,T)=(1−α)(x,y,T−1)+αI(x,y,T)
In the above, the constant a is set empirically to control the rate of adaptation (0<α<1). This depends on the frame rate and the expected rate of change of the scene.

In the past, computational barriers have limited the complexity of video motion detection methods. However, the advent of increased processing speeds has enabled more complex, robust models for real-time analysis of streaming data. These new methods allow for the modeling of real world processes under varying conditions. For example, one proposed probabilistic approach for pixel classification uses an unsupervised learning scheme for background-foreground segmentation. The algorithm models each pixel as a mixture of three probabilistic distributions. The pixel classes under consideration are a moving pixel (foreground), a shadow pixel, or a background pixel. As a first approximation, each distribution is modeled as a Gaussian distribution parameterized by its mean, variance and a weight factor describing its contribution to an overall Gaussian mixture sum. The parameters are initialized (during learning) and updated (during segmentation) using a recursive Expectation Maximization (EM) scheme such as the following:
i_{x,y}=w_{x,y}.(b_{x,y},s_{x,y},f_{x,y})
where

weights: w_{x,y}=(wᵣ, wₛ, wᵥ)

background: b_{x,y}˜N(μ_{b}, Σ_{b})

shadow: s_{x,y}˜N(μₛ, Σₛ)

foreground: f_{x,y}˜N(μ_{f}, Σ_{f})

Though this method has been proved to be very effective in detecting moving objects, some of the assumptions made in the initialization make it less robust. For example, the assumption that a foreground has a large variance will hamper the performance in extreme lighting conditions. Also the method ignores spatial and temporal contiguity, which is considered a strong relationship among pixels.

In one method, the values of a particular pixel are modeled as a mixture of Gaussians. Based on the persistence and the variance of each of the Gaussians of the mixture, the algorithm determines which Gaussians may correspond to background colors. Pixel values that do not fit the background distributions are considered foreground until there is a Gaussian that includes them with sufficient, consistent evidence supporting it. In such a method, at any time t, what is known about a particular pixel, {x0, y0}, is its history (over a period of time):
{X₁, . . . , Xₜ}={I(x₀, y₀, i):1≦i ≦t}
The recent history of each pixel, {X1, . . . , Xt}, is modeled by a mixture of K Gaussian distributions. The probability of observing the current pixel value then is:

$$P ( {X}_{t} ) = {\sum }_{i = 1}^{K} {ω}_{i , t} * η ( {X}_{t} , {μ}_{i , t} , {Σ}_{i , t} )$$

where K is the number of distributions, ω_{i,t} is an estimate of the weight (what portion of the data is accounted for by this Gaussian) of the i^{th} Gaussian in the mixture at time t, μ_{i,t} is the mean value of the i^{th} Gaussian in the mixture at time t, Σ_{i,t} is the covariance matrix of the i^{th} Gaussian in the mixture at time t, and where η is a Gaussian probability density function

$$η ( {X}_{t} , μ , Σ ) = \frac{1}{{( 2 π )}^{\frac{n}{2}} {\vert Σ \vert}^{\frac{1}{2}}} {ⅇ}^{- \frac{1}{2} {( {X}_{t} - {μ}_{t} )}^{T} {Σ}^{- 1} ( {X}_{t} - {μ}_{t} )}$$

K is determined by the available memory and computational power. Every new pixel value, Xₜ, is checked against the existing K Gaussian distributions, until a match is found. A match is defined as a pixel value within 2.5 standard deviations of a distribution. If none of the K distributions match the current pixel value, the least probable distribution is replaced with a distribution with the current value as its mean value, an initially high variance, and low prior weight.

One of the significant advantages of this method is that when something is allowed to become part of the background, it doesn't destroy the existing model of the background. The original background color remains in the mixture until it becomes the K^{th} most probable and a new color is observed. Therefore, if an object is stationary just long enough to become part of the background and then it moves, the distribution describing the previous background still exists with the same μ and σ². However, due to large computation involved in distribution matching and model parameters (μ & σ) calculation and update, Gaussian Mixture Model based schemes are generally not preferred in real-time video surveillance applications.

In another background based approach, an adaptive background subtraction method is used that combines color and gradient information for moving object detection to cope with shadows and unreliable color cues.

The stored background model for chromaticity is [μᵣ, μ_{g}, μ_{b}, σᵣ², σ_{g}², σ_{b}²] where r=R/(R+G+B),g=G/(R+G+B)and b=B/(R+G+B). The background model is adapted online using simple recursive updates in order to cope with such changes. Adaptation is performed only at image locations that higher-level grouping processes label as being clearly within a background region.
μₜ₊₁=αμₜ+(1−α)zₜ₊₁
σₜ₊₁²=α(σₜ²+(μₜ₊₁−μₜ)²)+(1−α)(zₜ₊₁−μₜ₊₁)²
The constant α is set empirically to control the rate of adaptation (0<α<1). This depends on the frame rate and the expected rate of change of the scene. A pixel is declared as foreground if |r−μᵣ|>3 max(σᵣ, σ_{rcam}), or if the similar test for g or b is true. The parameter σ_{rcam} refers to camera noise variance for red color component.

However, the background modeling based on chromaticity information doesn't capture object movement when the foreground matches the background. The approach uses first order image gradient information to cope with such cases more effectively. Sobel masks are applied along horizontal and vertical directions to obtain a pixel's gradient details. Similar to the color background model, the gradient background model is parameterized using the mean (comprising horizontal and vertical components) and the variance of gradients for the red, green and blue color components. Adaptive subtraction is then performed in a similar manner as that of color. A pixel is flagged foreground if either chromaticity or gradient information supports that classification.

Though the aforementioned methods of motion detection of the prior art perform an adequate job, at least in some circumstances, most, if not all, require a good deal of computational resources, and as such may not be all that suitable to real life and real time video detection. The art is therefore in need of an alternative video motion detection method.

### BRIEF DESCRIPTION OF THE DRAWINGS

FIG. 1 illustrates a flowchart of an example embodiment of a process to detect motion in video data.

FIG. 2 illustrates an example of output data from an example embodiment of a process to detect motion in video data.

FIG. 3 illustrates another flowchart of an example embodiment of a process to detect motion in video data.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

In an embodiment, a method of motion detection in video data involves block-based statistical processing of a difference frame. In this embodiment, the motion detection algorithm performs scene analyses and detects moving objects. The entire scene may contain objects-that are not of interest. Therefore, in an embodiment, motion is detected only for the objects of interest.

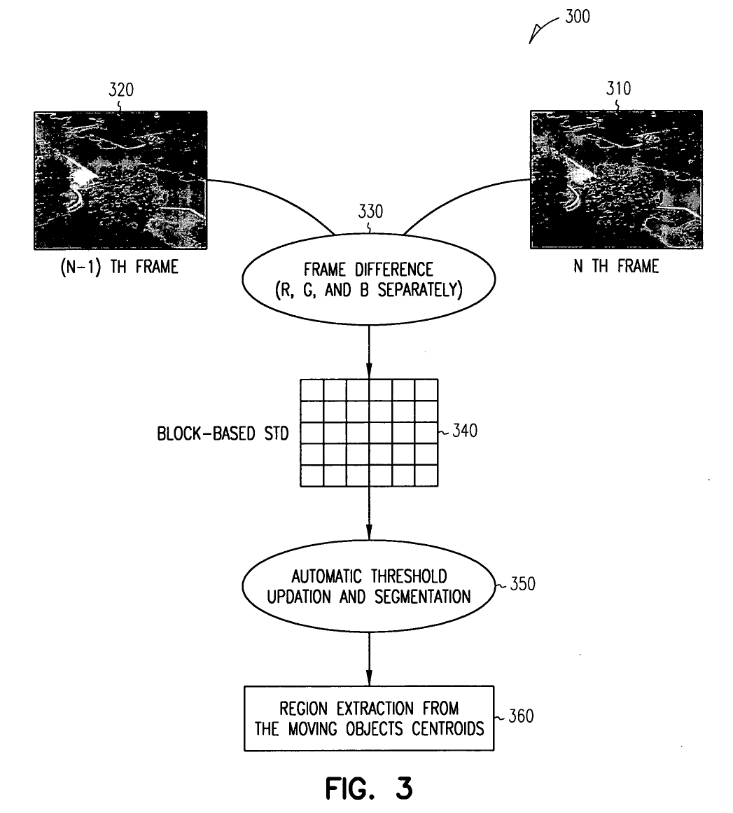

More specifically and referring to FIG. 3, an embodiment 300 uses block level processing of a difference image. The analysis is performed on the difference frame wherein the difference frame 330 is calculated from the Nth frame 310 and (N−1)th frame 320 (for the R, G and B channels respectively). However, unlike prior art methods, instead of individually processing each pixel in the frame, a block-based standard deviation 340 for the difference image 330 is calculated using, for example, typical block sizes of 3*3, 5*5, and 8*8. The maximum and the mean values of the standard deviation values for the current frame are computed from which a threshold factor is calculated as a factor of the maximum value of the standard deviation values. Only if the cumulative difference (difference between the cumulative mean of maximum values and the cumulative mean of the mean values) is greater than zero, then the image is thresholded at 350 using the above-mentioned threshold value. The binary images as a result of thresholding, obtained from each of the individual color components, are combined using an AND morphological operation. Finally, a heuristic-based region analysis 360 is performed to extract the exact shape/profile of an object.

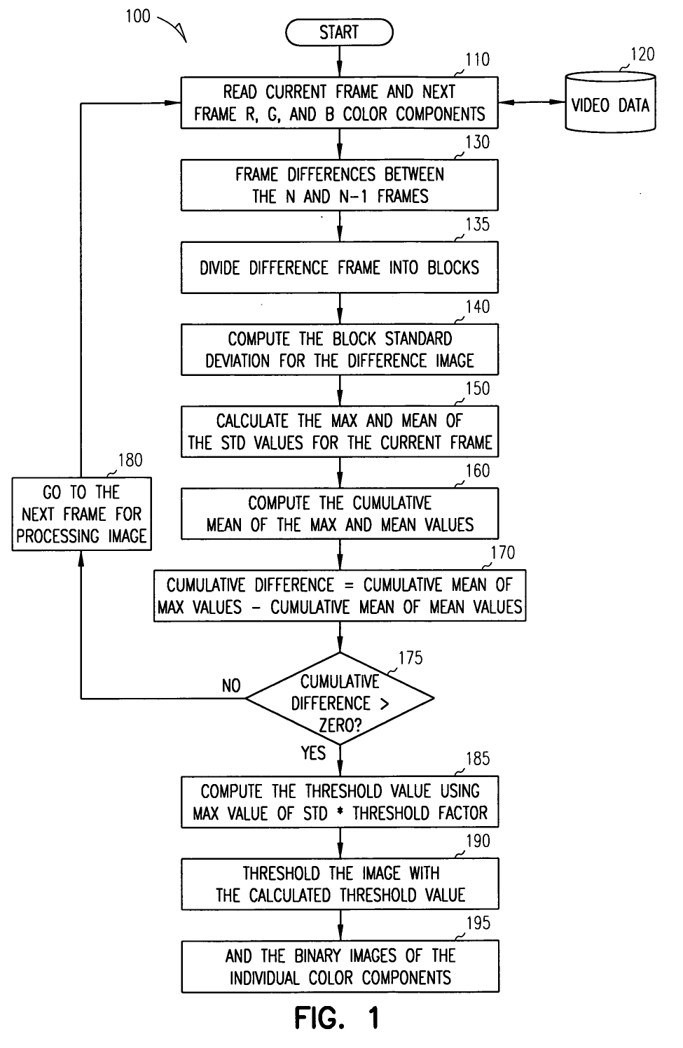

Referring to FIG. 1, a flowchart illustrates an example embodiment of a block-based statistical motion detection algorithm. A process 100 reads data at 110 from a video database 120. A current frame (Nth frame) and a subsequent frame ((N+1)th frame) are read from the video data, and in particular, the red, green, and blue channels of each pixel in the current and subsequent frames. After these data are read in, a frame difference between the current frame and the subsequent frame are calculated at 130—i.e. the difference between the pixel intensity values of the red, green, and blue channels of the current and subsequent frames. These differences between the pixel intensity values of the current frame and the pixel intensity values of corresponding pixels in the subsequent frame (i.e. pixels in the same bit map position in the subsequent frame) result in a difference frame.

A block standard deviation for this difference frame or image is calculated at 140. For this standard deviation calculation, typical block sizes are 3*3, 5*5, and 8*8, although other block sizes may also be used. The block standard deviation is calculated on each channel of the difference image. In an embodiment, the entire image is divided into a number of blocks at 135, and the standard deviation is calculated for each of these blocks (for each channel in the block). Thus, a set of standard deviation values equal to the number of blocks is now available for each channel. Thereafter, maximum values of these standard deviation sets (per channel) and mean values of these standard deviation sets (per channel) are computed at 150. Then, a cumulative mean of the maximum values and a cumulative mean of the mean values of these standard deviation sets are calculated at 160. The accumulation of maximum values of standard deviation and the mean values is performed per channel over several frames.

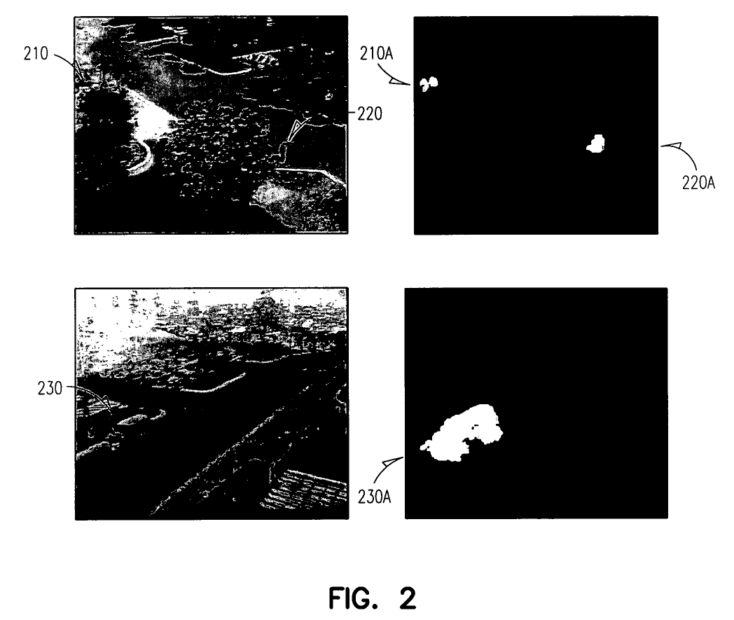

Then, a cumulative difference is calculated at 170, which is the cumulative mean of the maximum values (over several frames) minus the cumulative mean of the mean values (over several frames). If this cumulative difference is less than or equal to zero at 175, then the next frame is read at 180. Then, the previous subsequent frame becomes the current frame, and the processing of the R, G, and B color channels is performed for the new current and subsequent frames. However, if the cumulative difference is greater than zero, a threshold value is calculated at 185 using the maximum value of the standard deviation (of the current difference frame) multiplied by a threshold factor. In an embodiment, the threshold factor is a fixed value of 1/sqrt(2). Then, the image is thresholded at 190 with the calculated threshold value. In this embodiment, thresholding means that the intensity values of the current frame lying below the threshold value are labeled as “0”, and the intensity values of the current frame that are above the threshold value are labeled as “1” in a binary image. After thresholding, the binary images of the individual color components are ANDed at 195. The result of this AND operation gives the motion detected output as a binary image. An example of such an output is illustrated in FIG. 2. FIG. 2 shows in one example two people 210 walking and one person 220 walking, and the motion detected binary output 210a and 220a respectively. Similarly, a vehicle 230 in motion is illustrated along with its motion detected binary output 230a.

As can be seen from the above disclosure, an embodiment of a block-based standard deviation calculation reduces the computational complexity of motion detection. Moreover, the cumulative mean ensures the accuracy of the results by thresholding only those frames for which the values are greater than zero.

In the foregoing detailed description of embodiments of the invention, various features are grouped together in one or more embodiments for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the detailed description of embodiments of the invention, with each claim standing on its own as a separate embodiment. It is understood that the above description is intended to be illustrative, and not restrictive. It is intended to cover all alternatives, modifications and equivalents as may be included within the scope of the invention as defined in the appended claims. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

The abstract is provided to comply with 37 C.F.R. 1.72(b) to allow a reader to quickly ascertain the nature and gist of the technical disclosure. The Abstract is submitted with the understanding that it will not be used to interpret or limit the scope or meaning of the claims.

1. A method comprising:
creating a difference frame by determining the differences in pixel intensity values per channel between pixels in a first frame of video data and corresponding pixels in a second frame of video data;
dividing said difference frame into one or more blocks;
calculating standard deviations for each channel in each of said one or more blocks;
determining a maximum value and a mean value per channel of said standard deviations for said difference frame;
calculating a cumulative mean per channel of said maximum values and said mean values over a plurality of frames;
calculating a cumulative difference by subtracting said cumulative mean of said mean values from said cumulative mean of said maximum values;
determining that said cumulative difference is greater than zero;
calculating a threshold value;
labeling pixels of a current frame having intensity values below said threshold value as 0, and labeling pixels of said current frame having intensity values above said threshold value as 1, thereby giving a binary image of each channel; and
logically ANDing said binary images of each channel.

2. The method of claim 1, wherein said one or more blocks is selected from the group consisting of a 3*3 matrix, a 5*5 matrix, and an 8*8 matrix.

3. The method of claim 1, wherein said channels comprise a red channel, a green channel, and a blue channel.

4. The method of claim 1, wherein said threshold value is calculated by multiplying said maximum value of said standard deviation by a threshold factor.

5. The method of claim 4, wherein said threshold factor is equal to 1/sqrt(2).

6. The method of claim 1, further comprising:
determining that said cumulative difference is less than or equal to zero; and
reading a new frame of video data.

7. A machine readable medium comprising instructions thereon for executing a method comprising:
creating a difference frame by determining the differences in pixel intensity values per channel between pixels in a first frame of video data and corresponding pixels in a second frame of video data;
dividing said difference frame into one or more blocks;
calculating standard deviations for each channel in each of said one or more blocks;
determining a maximum value and a mean value per channel of said standard deviations for said difference frame;
calculating a cumulative mean per channel of said maximum values and said mean values over a plurality of frames;
calculating a cumulative difference by subtracting said cumulative mean of said mean values from said cumulative mean of said maximum values;
determining that said cumulative difference is greater than zero;
calculating a threshold value;
labeling pixels of a current frame having intensity values below said threshold value as 0, and labeling pixels of said current frame having intensity values above said threshold value as 1, thereby giving a binary image of each channel; and
logically ANDing said binary images of each channel.

8. The machine readable medium of claim 7, wherein said one or more blocks is selected from the group consisting of a 3*3 matrix, a 5*5 matrix, and an 8*8 matrix.

9. The machine readable medium of claim 7, wherein said channels comprise a red channel, a green channel, and a blue channel.

10. The machine readable medium of claim 7, wherein said threshold value is calculated by multiplying said maximum value of said standard deviation by a threshold factor.

11. The machine readable medium of claim 10, wherein said threshold factor is equal to 1/sqrt(2).

12. The machine readable medium of claim 7, further comprising:
determining that said cumulative difference is less than or equal to zero; and
reading a new frame of video data.

13. A method comprising:
creating a difference frame from a first frame of video data and a second frame of video data;
dividing said difference frame into a plurality of blocks;
calculating block-based standard deviations;
determining a maximum value of said standard deviations;
calculating a mean value of said standard deviations;
calculating a cumulative maximum value and a cumulative mean value over a plurality of frames;
calculating a threshold value from said maximum standard deviation; and
determining motion in said video data based on said threshold value.

14. The method of claim 13, wherein said difference frame is created by determining the differences in pixel intensity values per channel between pixels in said first frame and corresponding pixels in said second frame.

15. The method of claim 13, further comprising calculating a cumulative difference by subtracting said cumulative mean value from said cumulative maximum value.

16. The method of claim 15, further comprising:
determining that said cumulative difference is less than or equal to zero; and
fetching a new first frame of video data.

17. The method of claim 13, wherein said plurality of blocks is selected from the group consisting of a 3*3 matrix, a 5*5 matrix, and an 8*8 matrix.

18. The method of claim 13, wherein said calculations of said standard deviations are on a per channel basis.

19. The method of claim 13, wherein said threshold value is calculated by multiplying said maximum value of said standard deviation by a threshold factor.

20. The method of claim 19, wherein said threshold factor is equal to 1/sqrt(2).
